(19) United States
(12) Patent Application Publication
(10) Pub. No.: US 2022/0301453 A1
(43) Pub. Date: Sep. 22, 2022

(54) Reading Panel

(71) Applicant: Kara Van Slyke, Ingersol (CA)

(72) Inventor: Kara Van Slyke, Ingersol (CA)

(21) Appl. No.: 17/208,407

(22) Filed: Mar. 22, 2021

(51) Int. Cl. G09B 17/02; B42D 9/00

(52) U.S. Cl. CPC G09B 17/02; B42D 9/008

(57) ABSTRACT

A reading panel is disclosed. The reading panel is configured for holding a document having a plurality of lines of text or pattern and is configured for assisting a user to read the text or pattern provided on the document. The reading panel includes a flat sheet defining a pair of elongated openings extending in a lateral direction and arranged spaced apart and substantially parallel to each other. The reading panel also includes a strip separating the pair of elongated openings and adapted to slidably hold the document with the reading panel. The elongated openings together define a viewing window shaped and sized to facilitate a viewing and reading of one line of the plurality of lines to the user to enable a line by line reading of the document.

### TECHNICAL FIELD

The present disclosure relates, generally, to a reading panel. More particularly, the present disclosure relates to a reading panel to assist a line by line reading of a text or a pattern from a document.

### BACKGROUND

While reading text from a document it is often observed that a reader tends to skip lines or lose a place in the text. This problem gets exacerbated while the reader is reading on any uneven surface or traveling, leading to frequent loss of the place of the text. Similarly, it has been observed that the knitters and the crocheters while working on difficult and densely positioned patterns tend to lose one's eyes off the pattern. This may lead to stitching at the wrong place or even jumping of rows, resulting in the ruining of the pattern being knitted.

### SUMMARY

According to an aspect of the disclosure a reading panel is provided. The reading panel is configured for holding a document having a plurality of lines of text or pattern and is configured for assisting a user to read the text or pattern provided on the document. The reading panel includes a flat sheet defining a pair of elongated openings extending in a lateral direction and arranged spaced apart and substantially parallel to each other. The reading panel also includes a strip separating the pair of elongated openings and facilitating the holding of the document with the reading panel. The elongated openings together define a viewing window shaped and sized to facilitate a viewing and reading of one line of the plurality of lines to the user to enable a line by line reading of the document.

In an embodiment, a length of the viewing window is equal to or larger than a width of the document.

According to an embodiment, the flat sheet is a flexible sheet.

In one embodiment, the flat sheet is made of a translucent material.

In an embodiment, the flat sheet is made of an opaque material.

In one embodiment, the flat sheet includes a first portion defining the first elongated opening and the strip is attached to the first portion. The flat sheet also includes a second portion slidably engaged with the first portion and defines the second elongated opening therebetween. A width of the viewing window is adjusted by sliding the second portion relative to the first portion.

In an embodiment, at least one bracket is attached to the first portion and defines at least one channel. Further, the second portion includes a pair of legs arranged spaced apart and substantially parallel to each other. The legs are slidably arranged inside the at least one channel and are configured to slide relative to the at least one bracket to facilitate the sliding of the second portion relative to the first portion.

According to an aspect of the disclosure a method for reading a text or a pattern provided on a document is disclosed. The method includes providing a reading panel having a flat sheet and a strip. The flat sheet defines a pair of elongated openings extending in a lateral direction and arranged spaced apart and substantially parallel to each other. The strip separates the pair of elongated openings and facilitates a holding of the document with the reading panel. The elongated openings together define a viewing window shaped and sized to facilitate a viewing and reading of one line of the plurality of lines. The method further includes securing the document with the reading panel such that the flat sheet is positioned covering the document and the strip is arranged underneath the document. Moreover, the method includes aligning the viewing window to one of the plurality of lines provided on the document to enable a viewing and the reading of the line through the viewing window.

In an embodiment, aligning the viewing window includes sliding at least one of the reading panel or the document relative to other of the reading panel or the document.

In one embodiment, the flat sheet includes a first portion defining the first elongated opening and the strip is attached to the first portion. The flat sheet also includes a second portion slidably engaged with the first portion and defines the second elongated opening therebetween. The aligning the viewing window includes adjusting a width of the viewing window by sliding the second portion relative to the first portion.

In an embodiment, the reading panel includes at least one bracket attached to the first portion and defining at least one channel. The second portion further includes a pair of legs arranged spaced apart and substantially parallel to each other. The legs are slidably arranged inside the at least one channel and are configured to slide relative to the at least one bracket to facilitate the sliding of the second portion relative to the first portion.

In one embodiment, a length of the viewing window is equal to or larger than a width of the document.

According to one embodiment, the flat sheet is a flexible sheet.

In an embodiment, the flat sheet is made of a translucent material.

In an embodiment, the flat sheet is made of an opaque material.

For a more complete understanding of the present invention, reference is made to the following detailed description and accompanying drawings. In the drawing, like reference characters refer to like parts throughout the views in which.

### BRIEF DESCRIPTION OF THE DRAWINGS

FIG. 1 illustrates a reading panel secured with a document, in accordance with an embodiment of the disclosure;

FIG. 2 illustrates the reading panel having a pair of elongated openings and a strip separating the elongated openings, in accordance with an embodiment of the disclosure;

FIG. 3 illustrate a perspective view of the reading panel having a first portion and a second portion, in accordance with an embodiment of the disclosure; and

FIG. 4 illustrates a perspective view of the reading panel depicting a pair of legs of the second portion extending through a pair of brackets attached to the first portion.

### DETAILED DESCRIPTION

In the following description, for purposes of explanation, numerous specific details are set forth in order to provide a thorough understanding of the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like referenced numerals refer to like referenced elements throughout. The use of any term should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

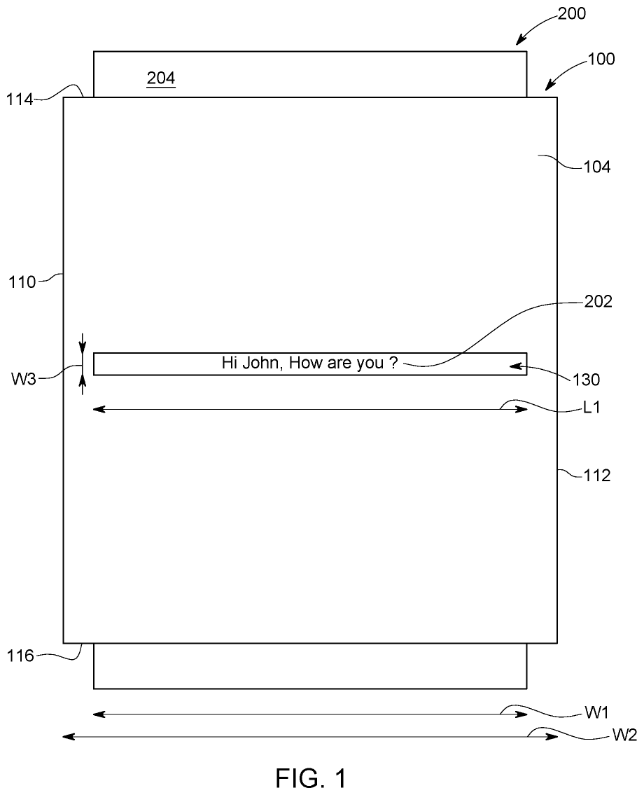

Referring to FIG. 1, a reading panel 100 secured to a document 200, for example, a paper, or a pattern, and adapted to hold the document 200 and assists a person in reading a text or a pattern provided on a surface of the document 200 is shown. It may be appreciated that the document 200 may be provided with the text or pattern in a line-by-line format and includes a plurality of lines 202 of text or pattern arrayed along a length of the document 200. The document 200 includes a first surface 204 and a second surface (not shown) arranged opposite to the first surface 204. In an embodiment, the plurality of lines 202 of the text or the pattern may be provided on the first surface 204, while the second surface is a blank surface. In some embodiments, both the first surface 204 and the second surface include the plurality of lines 202 of text or pattern.

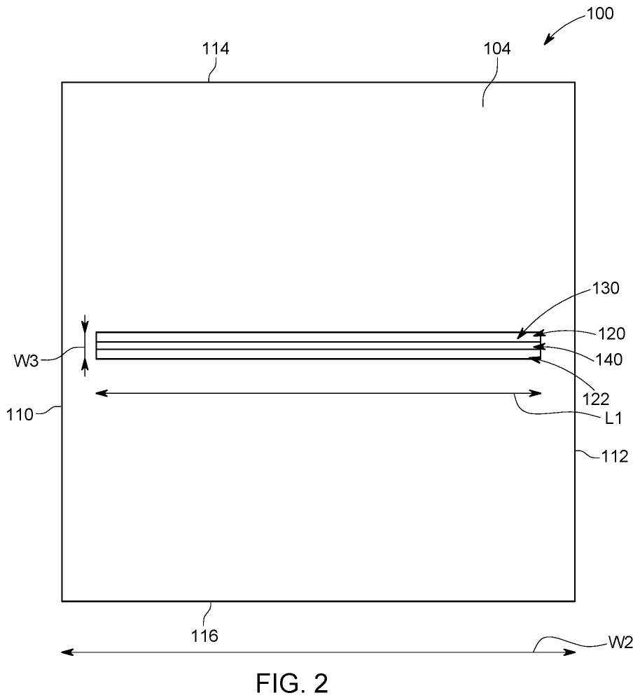

As shown in FIG. 1 and FIG. 2, the reading panel 100 is adapted to facilitate a line-by-line reading of the text or the pattern from the document 200 and is adapted to hold the document 200 and facilitates a sliding of the document 200 relative to the reading panel 100. The reading panel 100 includes a flat sheet 104 made of a translucent material or an opaque material to avoid any transfer of visuals information to the person from the document 200 through the flat sheet 104. In an embodiment, the flat sheet 104 may be a flexible sheet. Alternatively, flat sheet 104 may be a relatively hard sheet made of hard materials. As shown, the flat sheet 104 has a substantially rectangular structure with two longitudinal sides 110, 112 and two lateral sides 114, 116, and defines a pair of elongated openings, for example, a first elongated opening 120 and a second elongated opening 122, extending substantially parallel to the lateral sides 114, 116 of the flat sheet 104. Each of the openings 120, 122 extends through an entire thickness of the flat sheet 104. The openings 120, 122 together define a viewing window 130 for reading the text or pattern provided on the document 200.

Also, the pair of elongated openings 120, 122 may be arranged substantially centrally to the flat sheet 104. As shown, the first elongated opening 120 and the second elongated opening 122 are arranged spaced apart from each other and are separated from each other by a strip 140. The strip 140 is adapted to hold/secure the document 200 with the reading panel 100 and is adapted to abut or contact a surface of the document 200. For example, the strip 140 may contact the second surface of the document 200 arranged opposite to the first surface 204 of the document 200. Accordingly, the strip 140 is arranged underneath the document 200 in an assembly of the reading panel 100 with the document. Further, to enable the reading of the text or pattern only through the viewing window 130, a length of the flat sheet 104 may be greater or equal to a length of the document 200. Also, in an embodiment, a width ‘W1’ of the document 200 is smaller or equal to a width ‘W2’ of the flat sheet 104. In some embodiments, the width ‘W1’ of the document 200 may be substantially equal to a length ‘L1’ of the viewing window 130.

In an embodiment, a width ‘W3’ of the viewing window 130, and hence widths of the elongated openings 120, 122 are selected based on the dimensions of the text or the pattern in each line 202. Further, the width ‘W3’ of the viewing window 130 may be selected based on a spacing between two adjacent lines 202. For example, a width ‘W3’ of the viewing window 130 of may be increased or decreased to enable a viewing and reading of the text or the pattern having relatively large dimensions or smaller dimensions. In an embodiment, the elongated openings 120, 122 are slits defined along the width of the flat sheet 104.

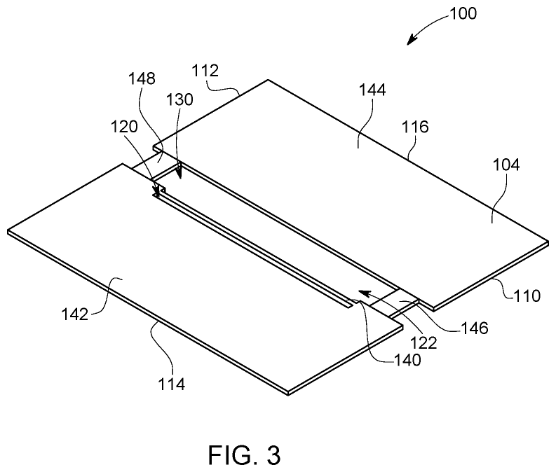

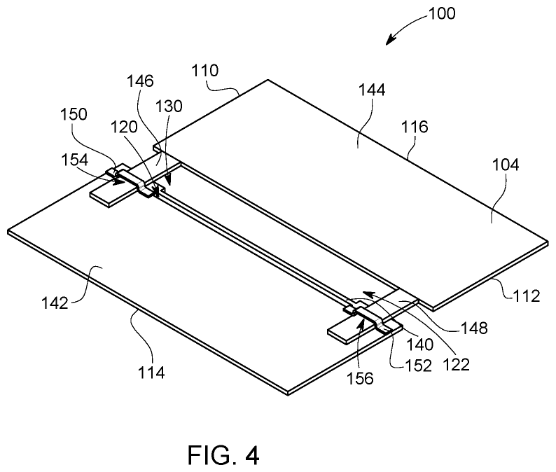

In an embodiment, the width ‘W3’ of the viewing window 130 may be dynamically adjusted. For so doing, as shown in FIGS. 3 and 4, the flat sheet 104 may include a first portion 142 and a second portion 144 slidably coupled to the first portion 142 and adapted to be moved relative to the first portion 142 to adjust a width of the second elongated opening 122 and hence the width ‘W3’ of the viewing window 130. As shown, the first portion 142 defines the first elongated opening 120 and the strip 140 is attached at a lower edge of the first portion 142, while the second elongated opening 122 is defined between the strip 140 and an edge of the second portion 144. As shown, the second portion 144 includes a pair of legs, for example a first leg 146 and a second leg 148, extending in a longitudinal direction and arranged spaced apart and substantially parallel to each other.

As shown, the legs 146, 148 extend in a direction of the longitudinal sides 110, 112 of the flat sheet 104. Referring to FIG. 4, the legs 146, 148 are slidably engaged with at least one bracket, for example, a first bracket 150 and a second bracket 152, coupled to the first portion 142 of the flat sheet 104. In an embodiment, the brackets 150, 152 may be integrally formed with the first portion 142. In some embodiments, the brackets 150, 152 are adhesively attached to the first portion 142. Although the adhesive attachment of the brackets 150, 152 with the first portion 142 is contemplated, it may be envisioned that the brackets 150, 152 may be attached to the first portion 142 by any other suitable means, such as, but not limited to, stitching, welding, fasteners, etc. Moreover, the second portion 144 is shown to include the legs 146, 148 and the brackets 150,152 are contemplated to be attached to the first portion 142, it may be envisioned that the first portion 142 may include legs 146, 148, while the brackets 156, 158 are attached to the second portion 144.

As shown, the brackets 150, 152 are attached to a bottom surface of the flat sheet 104 facing the document 200 when the reading panel 100 is engaged with the document 200. As with the legs 146, 148, the brackets 150, 152 are disposed proximate to the longitudinal sides 110, 112 of the flat sheet 104 and are arranged spaced apart from each other. As shown in FIG. 4, the first bracket 146 defines a first channel 154 through which the first leg 146 extends, while the second bracket 148 defines a second channel 156 through which the second leg 148 extends. The width ‘W3’ of the viewing window 130 is adjusted by sliding or moving the legs 146, 148 relative to the brackets 150, 152 through the channels 154, 156. Further, to prevent a complete disengagement of the legs 146, 148 from the brackets 150, 152, the legs 146, 148 may include stoppers (not shown) configured to engage with the brackets 150, 152. In some embodiments, a length of each of the brackets 150, 152 may be substantially equal to a length of a corresponding leg of the legs 146, 148.

Although the reading panel 100 having a single pair of elongated openings 120, 122 separated by the strip 140 is shown and contemplated, it may be envisioned that the reading panel 100 may include multiple pairs of elongated openings, each pair of elongated openings being separated by suitable size strip to facilitate the reading of patterns or the text of different sizes or dimensions.

A method for reading the text or pattern provided on the document 200 using the reading panel 100 is now described. The method includes securing/engaging the document 200 with the reading panel 100. For so doing, the user may extend the document 200 through both the elongated openings 120, 122, such that the majority of the document 200 is arranged below the flat sheet 104, while the strip 140 is disposed beneath the document 200. Accordingly, a portion of the document 200 containing the line 202 whose text or pattern is to be read by the user is arranged inside the viewing window 130 and is arranged above the strip 140. In this manner, the flat sheet 104 covers various lines 202 of the text or the pattern except the line 202 arranged inside the viewing window 130. Accordingly, the strip 140 holds the document 200 with the reading panel 100. Further, the reader/user may adjust the width ‘W3’ of the viewing window 130 by sliding the second portion 144 relative to the first portion 142 so that only one line 202 of the plurality of lines 202 is visible through the viewing window 130. After, reading the text or the pattern corresponding to the line 202 that is visible through the viewing window 130, the user may slide the document 200 or the reading panel 100 to align a subsequent line 202 with the viewing window 130. In this manner, the reading panel 100 facilitates a line by line reading of the text or the pattern provided on the document 200 by enabling the viewing of one line 202 at a time.

By placing the reading panel 100 on the document 200, the text or the pattern corresponding to only one line 202 is visible to the user for reading, and therefore, the user/reader does not lose the place while reading the document 200. Even in case of losing the place in the document 200, it is easy to search for the text within the same line. In addition, the reading panel 100 may be secured and positioned on the document 200 while the user is using a desk, an armchair and does not require any hard surface for facilitating the placement of the reading panel 100.

Further, the reading panel 100 is specifically helpful with knitters and crocheters working on difficult patterns with differing instructions for each line. Some knitting patterns are hard to read because the amount of information on the document 200 is so dense that the user's eyes can lose the place of the pattern or the line in the document 200. It takes time to find the correct line again after the user's eyes have jumped lines or the user has forgotten its place. The reading panel 100 reduces the errors reading the lines 202 of the patterns, and thereby reduces the time for searching of the position of the pattern in the line 202.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described to best explain the principles of the present disclosure and its practical application, to thereby enable others skilled in the art to best utilize the present disclosure and various embodiments with various modifications as are suited to the particular use contemplated.

What is claimed is:

1. A reading panel for holding a document having a plurality of lines of text or pattern and assisting a user to read the text or pattern provided on the document, the reading panel comprising:
a flat sheet defining a pair of elongated openings extending in a lateral direction and arranged spaced apart and substantially parallel to each other; and
a strip separating the pair of elongated openings and facilitating the holding of the document with the reading panel,
wherein the elongated openings together define a viewing window shaped and sized to facilitate a viewing and reading of one line of the plurality of lines to the user to enable a line by line reading of the document.

2. The reading panel of claim 1, wherein a length of the viewing window is equal to or larger than a width of the document.

3. The reading panel of claim 1, wherein the flat sheet is a flexible sheet.

4. The reading panel of claim 1, wherein the flat sheet is made of a translucent material.

5. The reading panel of claim 1, wherein the flat sheet is made of an opaque material.

6. The reading panel of claim 1, wherein the flat sheet includes
a first portion defining the first elongated opening and the strip is attached to the first portion,
a second portion slidably engaged with the first portion and defines the second elongated opening therebetween, wherein a width of the viewing window is adjusted by sliding the second portion relative to the first portion.

7. The reading panel of claim 6 further including
at least one bracket attached to the first portion and defining at least one channel, and
the second portion includes a pair of legs arranged spaced apart and substantially parallel to each other,
wherein the legs are slidably arranged inside the at least one channel and are configured to slide relative to the at least one bracket to facilitate the sliding of the second portion relative to the first portion.

8. A method for reading a text or a pattern provided on a document, the method comprising:
providing a reading panel having
a flat sheet defining a pair of elongated openings extending in a lateral direction and arranged spaced apart and substantially parallel to each other; and
a strip separating the pair of elongated openings and facilitating a holding of the document with the reading panel,
wherein the elongated openings together define a viewing window shaped and sized to facilitate a viewing and reading of one line of the plurality of lines;
securing the document with the reading panel such that the flat sheet is positioned covering the document and the strip is arranged underneath the document; and
aligning the viewing window to one of the plurality of lines provided on the document to enable a viewing and the reading of the line through the viewing window.

9. The method of claim 8, wherein aligning the viewing window includes sliding at least one of the reading panel or the document relative to other of the reading panel or the document.

10. The method of claim 8, wherein
the flat sheet includes a first portion defining the first elongated opening and the strip is attached to the first portion, and
a second portion slidably engaged with the first portion and defines the second elongated opening therebetween,
wherein aligning the viewing window includes adjusting a width of the viewing window by sliding the second portion relative to the first portion.

11. The method of claim 10, wherein
the reading panel includes at least one bracket attached to the first portion and defining at least one channel, and
the second portion includes a pair of legs arranged spaced apart and substantially parallel to each other, wherein the legs are slidably arranged inside the at least one channel and are configured to slide relative to the at least one bracket to facilitate the sliding of the second portion relative to the first portion.

12. The method of claim 8, wherein a length of the viewing window is equal to or larger than a width of the document.

13. The method of claim 8, wherein the flat sheet is a flexible sheet.

14. The method of claim 8, wherein the flat sheet is made of a translucent material.

15. The method of claim 8, wherein the flat sheet is made of an opaque material.
